(19) United States
(12) Patent Application Publication
(10) Pub. No.: US 2017/0311573 A1
(43) Pub. Date: Nov. 2, 2017

(54) Rescue Collar

(71) Applicant: Trustin Sigmon, Melrose, FL (US)

(72) Inventor: Trustin Sigmon, Melrose, FL (US)

(21) Appl. No.: 15/143,706

(22) Filed: May 2, 2016

(51) Int. Cl. A01K 29/00; E05B 47/00; A01K 27/00; A01K 15/02; E05B 65/00

(52) U.S. Cl. CPC A01K 29/005; E05B 65/00; E05B 47/00; A01K 15/022; A01K 27/001; A01K 15/023; A01K 27/009

(57) ABSTRACT

An interactive system for monitoring health and movement of an animal has an elongated band adapted to encircle on a body part of an animal, a tracking chip to monitor movement of the animal within and outside of a geofence, a lock to provide an opening and closing of the elongated band, a means for health monitoring to collect a data set for a plurality of vital signs of the animal, and a user interface to notify a pet owner about the outside movement of the animal from the geofence. Further, the system enables the authorized users to log into the communicating device such as a computer or any other computing device and track the movement and view health information of the animal while it needed.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to the field of training, tracking, and monitoring animals. The invention, particularly relates to a system and method for wirelessly controlling a device attached to an animal.

### 2. Description of Related Art Including Information Disclosed Under 37 CFR 1.97 and 37 CFR 1.98

A pet can be a great friend. The pet owner always gives his best to monitor the health and the movement of the pet in an area. According to a survey every year around millions of pets lost from their own either due to deprived health or non-monitoring of the movement, which means that every day someone goes through the heartbreak of losing an animal friend. Each year, more than 10 million pets become lost and nearly 90 percent of those pets without identification never make it home. Many pets are not only reflected in the value of the money, they have even an indispensable member of the family living status. But in real life, due to various reasons, every year many pets get lost, resulting in economic losses to the owner, while offering spiritual unpleasant. If there is a pointing device to timely reflect the movement and health status of the animal which will undoubtedly be of such economic, spiritual loss of effective protection.

In the conventional animal location monitoring system, i.e. adapted to CDMA, GPS communication module, combined with compact, high-sensitivity antenna, health monitoring sensor and a modular architecture design with a sophisticated collar shape.

There have been a number of solutions provided for utilizing an electronic means for location tracking of the animal, and few of them have been discussed below:

U.S. Pat. No. 6,720,879 B2 relates to an animal collar for locating and tracking animals. The animal collar is provided with a digital video camera that may be remotely controlled transmit real time, full motion video signals over a broadband wireless communication network to allow a pet owner to view the immediate surroundings of a lost pet. The animal collar is further provided with a global positioning (GPS) unit that communicates with GPS satellites to determine the geographic coordinates of the animal collar.

U.S. Pat. No. 7,705,736 B1 pertains a GPS data acquisition collar incorporating an individualized rugged watertight collar that monitors factors, including GPS location, gazing patterns, elevation, feeding patterns, temperature, movement speed, sleep patterns and signaling or beacon tracking options. Additionally, the present invention provides options for visual representation or programming alerting of factors that may affect an animal or herd of animals in a monitored and recorded environment.

U.S. Pat. No. 8,615,252 B2 describes a collar tracking system that includes an RFID system with a modem, an electric fence with a plurality of boundaries that is in communication with the RFID system and a plurality of power modes, a plurality of electronic circuitry that includes a battery, an open charging electrode, a smart protection circuitry to prevent a short to the battery and an antenna.

U.S. Pat. No. 5,857,433 A discloses a device for training/controlling and tracking an animal. The device includes both an aversive stimuli unit and a global positioning satellite system unit in the housing. Coupled to the housing is a harness, collar or other mechanism for attaching the device to an animal. The aversive stimuli unit is remotely operable using a hand-held control unit to aversively stimulate the animal wearing the housing. The global positioning satellite unit coupled to the housing allows determination of the animal's position relative to the operator of the hand-held control unit. A preferred embodiment of the present invention is designed particularly for tracking and training or controlling one or more dogs.

U.S. Pat. No. 8,543,134 B2 relates to an animal collar having cellular network connectivity to facilitate tracking of an animal and greater communication therewith over great distances. The device further provides improved low light visualization of the collar and the ability to communicate with the animal or an individual who has recovered the animal after it has strayed away from its home. Applications of the present invention include recovery of a lost or stolen pet, facilitating communication during a hunting exercise, communication with service animals in the military/law enforcement/rescue operations, and finally for animal training purposes.

The aforesaid documents and other similar solutions may strive to provide a sophisticated tracking system for animal; however, they still have a number of limitations and shortcomings such as, but not limited to, inability to provide a pet owner controlled locking mechanism and further, the wearable device can also be easily removed from the animal by any anonymous, or even it might be fall off from the pet's body part. The above mentioned prior arts can only perform certain aspects say for example, provides a location monitoring system using a means of satellite communication with a GPS device and the like.

Accordingly, there remains a need in the prior art to have an improved system and method thereof, for an efficient and dynamic animal health and movement tracking, which also enables the pet owner to have a better locking mechanism by providing a user defined code, therefore overcome the aforesaid problem and shortcomings.

### BRIEF SUMMARY OF THE INVENTION

In the view of the foregoing disadvantages inherent in the known types of animal health monitoring and movement tracking system now present in the prior art, the present invention provides an improved interactive system for monitoring health and movement of an animal. As such, the general purpose of the present invention, which will be described subsequently in greater detail, is to provide a new and improved interactive system for monitoring health and movement of an animal with an elongated band, i.e. used to monitor the activity and health of the animal and operated by a user defined number code or thumb impression, which has all the advantages of the prior art and none of the disadvantages.

An object of the invention is to provide an interactive system that allows user to track his/her animal live from their mobile or wireless communicating device using GPS location and also provides the ability to track and monitor animal activity, sleep, temperature and the other body vital signs.

It is another object of the present invention to provide the interactive system that includes an elongated band which is adapted to encircle on a body part of the animal for monitoring health and movement of the animal.

It is another object of the present invention to provide the user interface, which is operably adapted to provide a cellular connectivity between the elongated band and the communicating device.

It is another object of the present invention to provide the interactive system that allows authorized users to log in to the communicating device such as a smartphone, computer or any other computing device and monitor the movement and various health aspects such as sleeping pattern, body temperature, body weight of the animal.

It is another object of the present invention to provide the interactive system that helps other persons to be added by the animal owner in the user interface to keep people of interest up to date on the location of the animal and activity monitoring information.

It is another object of the present invention to provide the interactive system that stores the movement data of the animal so that the animal owner can see where the animal has been traveled and wondered, which is useful for people who are recreational with their animals.

It is another object of the present invention to provide the elongated band in which embodies a speaker, a digitalized-screen that display multiple messages as well as the information about the animal and the contact information of the animal owner on the digitalized-screen.

It is another object of the present invention to provide the ability for the animal owner to create a designated zone using their communicating device such as a smartphone or computer to set a boundary area around a chosen location for the animal and if the animal exceeds that boundary, the elongated band sends a notification alert saying their animal has left his/her boundary and shows an exact live feed location of the animal with a highlighted route between the animal owner and the animal all available on the communicating device.

It is another object of the present invention to provide the elongated band, which is made from a waterproof material such as a steel braided cable with a rubber coating or a durable metal and the like.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of an interactive system with an elongated band for monitoring health and movement of an animal in accordance with an embodiment of the present invention.

FIG. 2 illustrates the front view of the elongated band as shown in FIG. 1.

FIG. 3 illustrates an information screen of a digital elongated band as shown in FIG. 2.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention generally provides an interactive system for monitoring health and movement of an animal that comprises of an elongated band, a tracking mechanism, a locking means, a means for health monitoring (8), a charging light indicator (2), a speaker (9), an information screen (3) and a user interface. The one end of the elongated band is configured to provide an information screen to display the related information about the animal or pet owner such as contact info, pet name, pet ID and the like. The elongated band is also having the rings for attaching a leash (4) and tags to the elongated band.

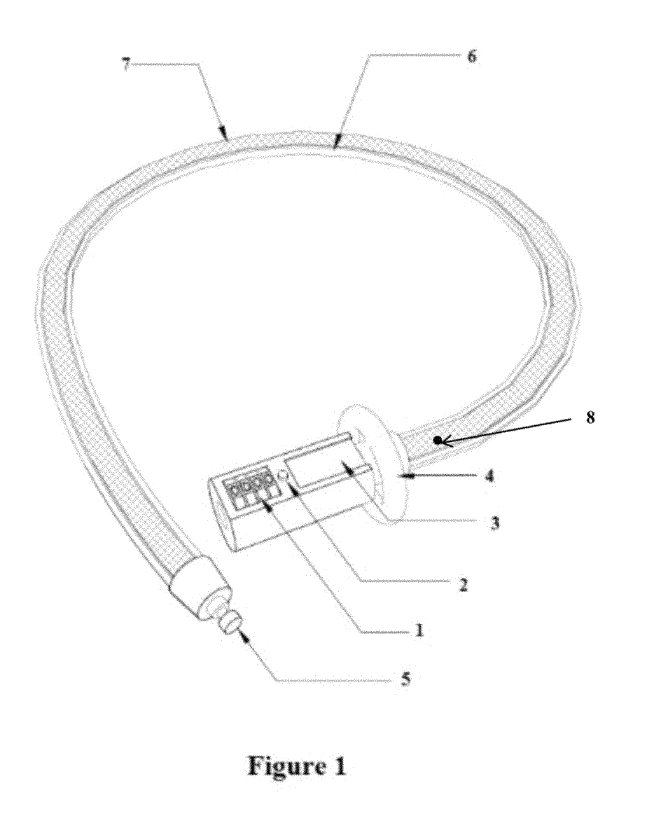

As shown in FIG. 1, a method for monitoring health and movement of an animal, comprising the steps of wearing or encircles an elongated band to a body part of the animal, having an integrated tracking, health and temperature monitoring system, which is connected to a GPS device; initiating the animal monitoring on the communicating device using the elongated band such as an animal collar; receiving periodically a related position monitoring data using a cellular connectivity; receiving the monitored data from the cellular network on the communicating device; and determining the location of the animal after using the monitored data. Further, the elongated band is configured to have a locking means, which is only released from the animal by a user defined code or correct thumb print recognition.

In accordance with an embodiment of the present invention, the interactive system for monitoring health and movement of an animal, including an elongated band adapted to encircle on a body part of the animal, a tracking chip to monitor movement of the animal within and outside of a geofence, a locking means to provide an opening and closing of the elongated band. The locking means is having a padlock (1) at one end and a connection lock (5) at the other end of the elongated band. The elongated band is made of two sections, in which first section is made of, but not limited to, steel cable (6) and the second section is, but not limited to, coated with the rubber (7), although any other suitable material can also be used for manufacturing. In addition, a means for health monitoring (8), i.e a sensor to collect a data set for a plurality of vital signs of the animal, a user interface to notify a pet owner about the outside movement of the animal from the geofence and the user interface further notifies the pet owner about the data set collected by the means for health monitoring for the animal using a communicating device. Further, the user interface is adapted to create the geofence for the animal, i.e. the web or mobile application.

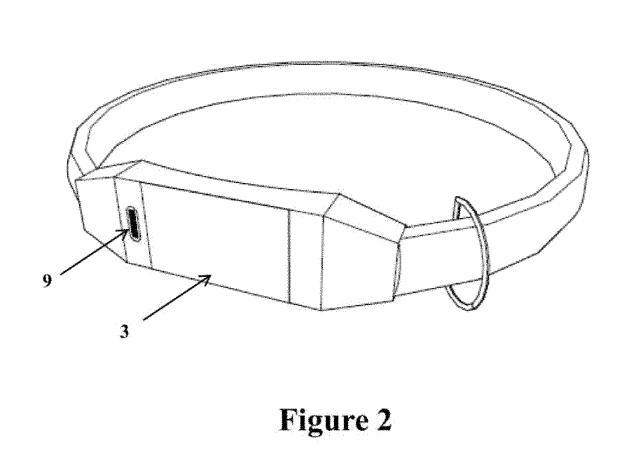

FIG. 2 is the front view of the elongated band for the animal tracking, health and temperature monitoring system of FIG. 1. The present invention provides a very efficient and dynamic system for monitoring the health and movement of an animal. The system is configured to provide a tracking mechanism in the elongated band which coiled in the housing of the band. Further, the tracking mechanism is used for detecting the geographical coordinates and the location of the animal, and sends the monitored data into the database of the communicating device via the data communication network. The communicating device is having a user interface to provide the monitored data in human readable or intelligible form. Further, the elongated band is having a speaker (9), which is connected to the communicating device of the owner of the animal for giving voice command to the animal. The communicating device comprises a display unit, a processor and a memory. The memory of the communicating device is used to store a data set for the movement of the animal within and outside of the geofence and also stores the data about plurality of vital signs such as a sleeping pattern data, a weight variation data, a height variation data, a temperature variation data and a physical activity data. for the animal.

In accordance with another exemplary embodiment of the present invention, the locking means is operably adapted to the digital locking mechanism which includes a thumb impression (3) to release the band from the animal. Further, the rechargeable battery is provided with the elongated band, i.e. recharged with the inbuilt charging port and distributes the power to the included electronic elements. Also, the charging light indicator depicts the status of the battery. The user interface is adapted to detect a remaining battery percentage of the rechargeable battery of the elongated band using the communicating device. If the elongated band drops below a certain battery percentage it will notify the owner, then go into a sleep mode so that the elongated band does not fully loose all battery life so that the owner would be able to turn the elongated band on, only to remove for recharging. This will prevent the collar from losing all battery life and being unable to be electronically remove.

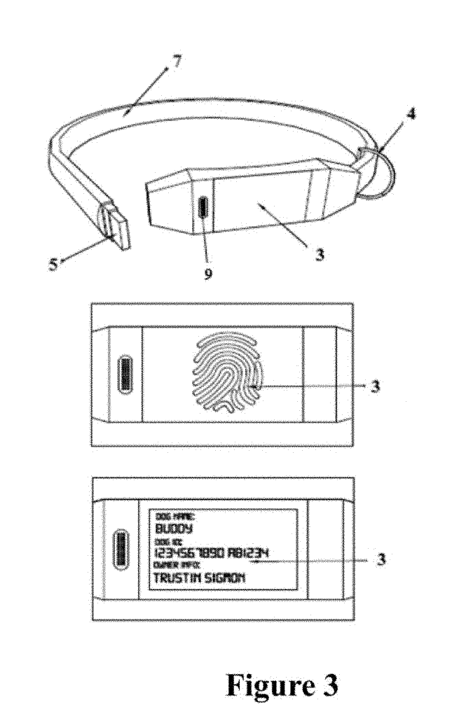

FIG. 3 illustrates an information screen of the digital elongated band as shown in FIG. 2. The present invention is configured to provide a digital information screen (3) with a speaker. The digital information screen is used for entering the thumb impression and display the animal related information such as animal name, owner contact info, animal ID and the like. The means for locking (5) is operably adapted to open by the thumb impression of an authorized person, which is might be the pet owner or trainer, although for the mechanical locking means, a unique number is applied on the locking pad of the elongated band (7). Further, the uniquely built-in oval indented metal leash (4) link placed in the middle of the collar were as the leash can be connected to the collar.

The above-mentioned system for monitoring health and movement of an animal provides a flexible way to track the movement of the animal by simply encircles an elongated band such as collar onto the body part of the animal. The interactive system is also monitoring the data about the plurality of vital signs such as a sleeping pattern data, a weight variation data, a height variation data, a temperature variation data and a physical activity data. The system provides, but not limited to, a ring shape device which has a locking means, i.e. only operated by an authorized person for which it is assigned. Further, the shape, size and color of the collar is manufactured as per the manufacturer need and not limited to a specific appearance. In addition, it allows the authorized person to log into the communicating device and track the geographical coordinates or the GPS location, and access information regarding the health of the animal. It is helpful in tracing the animal in less span of time. It eliminates the old process of tracing someone, and provides a robust locking mechanism.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. An interactive system for monitoring health and movement of an animal, comprising:
an elongated band adapted to encircle on a body part of said animal;
a tracking chip to monitor movement of said animal within and outside of a geofence;
a locking means to provide an opening and closing of said elongated band;
a means for health monitoring to collect a data set for a plurality of vital signs of said animal;
a user interface to notify a pet owner about said outside movement of said animal from said geofence; and
wherein said user interface further notifies said pet owner about said data set collected by said means for health monitoring for said animal using a communicating device.

2. The system according to claim 1, wherein said elongated band is configured to provide a housing for said tracking chip and said means for health monitoring.

3. The system according to claim 2, wherein said housing comprises a rechargeable battery, a charging port, a speaker, an information screen and a charging light indicator.

4. The system according to claim 3, wherein said speaker is connected to said communicating device for giving voice commands to said animal.

5. The system according to claim 3, wherein said rechargeable battery is configured to provide power supply to said elongated band.

6. The system according to claim 1, wherein said elongated band is a waterproof animal collar.

7. The system according to claim 1, wherein said tracking chip is connected to a global positioning system for detecting said movement of said animal.

8. The system according to claim 1, wherein said locking means is a mechanical lock.

9. The system according to claim 1, wherein said locking means is a digital lock.

10. The system according to claim 1, wherein said locking means is operated by a user code.

11. The system according to claim 10, wherein said user code is a unique number for said mechanical lock.

12. The system according to claim 10, wherein said user code is a user thumb impression for said digital lock.

13. The system according to claim 1, wherein said communicating device is selected from a group consisting of computer, laptop, tablet, smartphone and any combination thereof.

14. The system according to claim 1, wherein said communicating device comprises a display unit, a processor and a memory.

15. The system according to claim 14, wherein said memory is used to store a data set for said movement of said animal within and outside of said geofence.

16. The system according to claim 14, wherein said memory is used to store said data set for said plurality of vital signs for said animal.

17. The system according to claim 1, wherein said data set comprises a sleeping pattern data, a weight variation data, a height variation data, a temperature variation data and a physical activity data for said animal.

18. The system according to claim 1, wherein said user interface is adapted to create said geofence for said animal.

19. The system according to claim 1, wherein said user interface is a web application.

20. The system according to claim 1, wherein said user interface is a mobile application.

21. The system according to claim 1, wherein said user interface is adapted to detect a remaining battery percentage of said rechargeable battery of said elongated band using said communicating device.

22. The system according to claim 1, wherein said user interface is operably adapted to provide a cellular connectivity between said elongated band and said communicating device.
